(19) United States
(12) Patent Application Publication
(10) Pub. No.: US 2010/0113006 A1
(43) Pub. Date: May 6, 2010

(54) CELL CALIBRATION

(75) Inventors: Ambika Pajjuri, Sunnyvale, CA (US); Scott Fullam, Palo Alto, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: 2WIRE, INC., San Jose, CA (US)

(21) Appl. No.: 12/264,706

(22) Filed: Nov. 4, 2008

(51) Int. Cl. H04W 24/00; H04W 4/12; H04M 1/00

(52) U.S. Cl. 455/423; 455/466; 455/561

(57) ABSTRACT

A system and method for enabling an access point to transmit a pilot signal to a mobile device operating in a specified location until a pilot signal acknowledgement is received from the mobile device indicating the pilot signal was detected at the specified location. The system and method further enabling the access point to automatically set an operational power level for the pilot signal based on a power level at which the pilot signal was being transmitted when the pilot signal acknowledgement was received.

### TECHNICAL FIELD

Embodiments of the invention relate to the field of wireless telecommunication networks, and more particularly, to a system and method for automatically setting power levels within an access point to establish a calibrated pilot signal boundary for the access point.

### BACKGROUND

Conventional wireless telecommunication networks, such as cellular and digital wireless telephone networks, create a geographically large coverage area through the use of conventional network Base Stations (e.g., Base Transceiver Station (BTS) or “Node-B” cell towers having antennas for transmit and receive functions), Radio Network Controllers (RNCs), Base Station Controllers (BSCs), Mobile Switching Centers (MSCs), and other equipment common to wireless telephony network deployments.

Each conventional network Base Station operating within the wireless telephony network broadcasts a pilot signal at a specific power level that is optimized by network engineers to provide as large of a coverage area as possible, without excessively overlapping or interfering with surrounding Base Stations operating within the conventional network, and the corresponding coverage area of those Base Stations. The pilot signal broadcast by each Base Station notifies mobile devices operating within its coverage area of the presence of a network entry point capable of providing access to conventional network services.

When a mobile device, such as a mobile telephone, comes within range of a pilot signal from a Base Station, the mobile device may attempt to transition telephony and data communications from a surrounding Base Station to the Base Station associated with the pilot signal. Excessive overlap in the pilot signals from Base Stations operating on the network can degrade overall network performance through interference and cause mobile devices to operate less efficiently as they expend energy (e.g., battery life) to “hop” between one Base Station and another, again and again.

To reduce the negative affects of overlapping pilot signals, trained network engineers carefully calibrate the pilot signal boundary around a conventional network Base Station by adjusting operational parameters (e.g., pilot signal power level settings) of each Base Station based on geographic terrain, obstacles (e.g., trees, buildings), population density, signal frequency, and other available parameters. Typically, power levels are manually set, and then through trial and error, repeated manual adjustments are made, based on measurements taken in the field that aid the engineers in determining whether a pilot signal boundary (e.g., a coverage range) established by the pilot signal meets the required deployment criteria for the wireless telecommunications network. The process may require several iterations and extensive technician man hours until suitable results are obtained and a properly calibrated pilot signal boundary is established.

The process of deploying and calibrating a conventional network Base Station is costly due to the trial and error based mechanisms of manually calibrating the pilot signal boundary necessitating the use of highly skilled engineers to perform the complex work. However, because each conventional network Base Station deployed provides network coverage for a potentially large number of mobile devices, the costs associated with such a manual trial and error calibration can be distributed over many telecommunication service subscribers, and thus recouped within a reasonable time period.

In some situations, it is desirable for a service provider that operates such a network to deploy wireless base stations that are capable of establishing comparatively small network coverage areas. However, because the wireless base stations provide only small coverage areas, it is far too costly to have a trained network engineer manually calibrate, through trial and error, every wireless base station that is deployed by the service provider, as the costly configuration process would be distributed among only a small number of service subscribers, and may never be recouped. There may further be logistical constraints due to, for example, a shortage of trained engineers to manually calibrate a large number of deployed wireless base stations. Moreover, typical service subscribers (e.g., end-users) utilizing small coverage area base stations are not trained to perform the complex trial and error power level adjustments required to properly calibrate a pilot signal boundary manually, without the aid of a trained engineer.

Consequently, wireless service providers that deploy such wireless base stations conventionally do not calibrate the wireless base stations, manually or otherwise, but rather, set the pilot signal's broadcast power level to a standard “default” setting, that provides a uniform operational pilot signal power level for all deployed wireless base stations, without regard to the unique characteristics of each particular wireless base station deployment or its operational environment. This “one size fits all” approach results undesirable pilot signal boundaries in many, if not most, situations. For example, the pilot signal may be too weak to establish a proper boundary around a large rural home or a small office building, or may broadcast at too powerful of a level to efficiently operate within, for example, a small apartment within a densely populated urban center, thus causing undesirable interference with neighboring wireless base stations or with the surrounding conventional network.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 illustrates an exemplary network architecture in which embodiments of the present invention may operate;

FIG. 2 is an alternative view of an exemplary network architecture in which embodiments of the present invention may operate;

FIG. 3A is a diagrammatic representation of an access point for sending a relocation prompt to a mobile device and receiving a pilot signal acknowledgement from the pilot device, in accordance with one embodiment of the present invention;

FIG. 3B is a diagrammatic representation of a mobile device for receiving a relocation prompt from an access point and sending a pilot signal acknowledgement to the access point, in accordance with one embodiment of the present invention;

FIG. 4A is a flow diagram illustrating a method for sending a relocation prompt to a mobile device and receiving a pilot signal acknowledgement from the pilot device, in accordance with one embodiment of the present invention;

FIG. 4B is a continuation flow diagram illustrating the method from FIG. 4A;

FIG. 5 is a flow diagram illustrating a method for receiving a relocation prompt from an access point and sending a pilot signal acknowledgement to the access point, in accordance with one embodiment of the present invention; and

FIG. 6 illustrates a diagrammatic representation of a machine in the exemplary form of a computer system, in accordance with one embodiment of the present invention.

### DETAILED DESCRIPTION

In the following description, numerous specific details are set forth such as examples of specific systems, languages, components, etc., in order to provide a thorough understanding of the present invention. It will be apparent, however, to one skilled in the art that these specific details need not be employed to practice the present invention. In other instances, well known materials or methods have not been described in detail in order to avoid unnecessarily obscuring the present invention.

Described herein are a system and method for enabling an access point to transmit a pilot signal to a mobile device operating in a specified location until a pilot signal acknowledgement is received from the mobile device indicating the pilot signal was detected at the specified location. The system and method further enabling the access point to automatically set an operational power level for the pilot signal based on a power level at which the pilot signal was being transmitted when the pilot signal acknowledgement was received.

In some embodiments, an access point pilot signal is calibrated to its particular operational environment by instructing a mobile device to locate to a specified position, such as the front door of a house, an adjoining wall between two apartments in an apartment building, or a “worst case” location within a building, such as a basement or other location far away from the access point. The mobile device is further instructed to acknowledge, from the specified location, detection of the pilot signal. Once the mobile device is at the specified location, the mobile device sends an acknowledgement to the access point indicating the pilot signal was detected at the specified location. The access point then records the power level at which the pilot signal was transmitted when the acknowledgment was received, and automatically calibrates an operational pilot signal power level, without human interaction, based on the recorded power level.

In some embodiments, the access point instructs the mobile device to relocate to multiple locations (e.g., a front door, a driveway, a backdoor, an interior point furthest from the access point, etc.) and acknowledge the pilot signal from each location when the pilot signal is strong enough to be detected. The access point automatically records the power level at which the mobile device acknowledges the pilot signal from each location, and then automatically calibrates the operational pilot signal power level based on the multiple recorded power levels determined from the various specified locations.

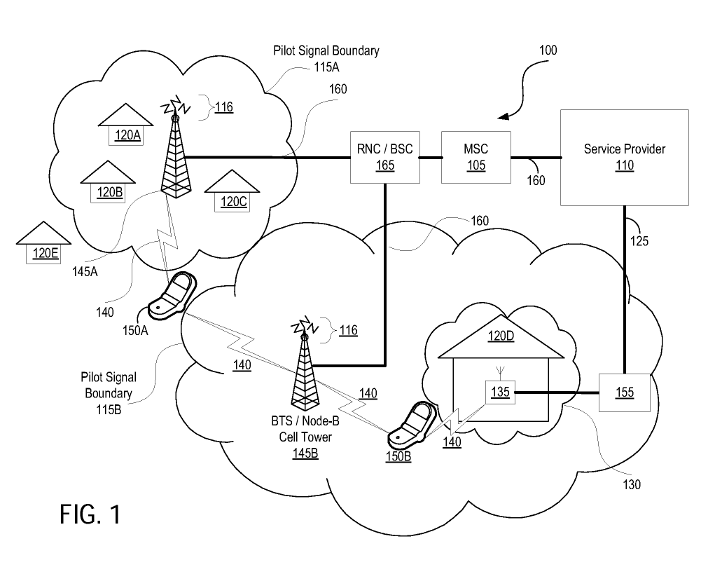

FIG. 1 illustrates an exemplary network architecture 100 in which embodiments of the present invention may operate. The network architecture 100 may include Service Provider (SP) 110 which is communicably interfaced with Mobile Switching Center (MSC) 105 via SP backhaul 160. MSC 105 is further connected with BTS/Node-B cell towers 145A and 145B via SP backhaul 160.

SP 110 may be a telecommunications company that provides wireless voice services, wireless data services, or both. SP 110 may operate a wireless communications network infrastructure that communicates over a licensed band of wireless spectrum and operates in accordance with well known wireless communication protocols. Such protocols may include, for example, a Universal Mobile Telecommunications System (UMTS) compatible protocol, a Global System for Mobile communications (GSM) compatible protocol, a Code Division Multiple Access (CDMA) compatible protocol, a Worldwide Interoperability for Microwave Access (WiMAX) compatible protocol, and so forth.

SP 110 communicates with MSC 105 via an Internet Protocol (IP) based SP backhaul 160, which is a high-speed data connection owned or leased by SP 110. For example, SP backhaul 160 may be a digital signal 1 (DS1 or T1) communications interface providing network connectivity between SP 110 and MSC 105 which is financially supported by SP 110 as an overhead component of operating network 100.

MSC 105 provides interoperability between an SP's 110 wireless telephony network and conventional land-line networks, as well as other wireless telephony networks not operated by SP 110. MSC 105 further provides connectivity between multiple mobile devices operating within SP's 110 network. MSC 105 performs other conventional MSC responsibilities including setting up and releasing end-to-end connections between telephony devices, handling usage tracking for billing purposes, and coordinating handoffs between conventional network Base Stations.

Each MSC 105 typically manages multiple Radio Network Controllers (RNCs) or Base Station Controllers (BSCs) 165 depending on whether the network infrastructure corresponds with second generation (2G) or third generation (3G) mobile telecommunication standards. Each RNC/BSC 165 in turn manages multiple cellular towers, such as Base Transceiver Station (BTS) or “Node-B” cell towers 145A and 145B, again depending on whether the network infrastructure corresponds with 2G or 3G mobile telecommunication standards. Each cell tower 145 is responsible for handling the functions related to wireless radio communications with mobile devices operating within an infrastructure coverage area 115 provided by the cell tower 145. Such functions include paging of mobile devices, allocating radio channels, radio signal quality management, and coordinating voice and data communications between mobile devices in the cell tower's 145 infrastructure coverage area 115. In some telecommunication networks, functions of MSC 105, RNC/BSC 165, and BTS/Node-B cell towers 145 may be broken down into additional physical or logical components, however, the basic overall wireless network infrastructure (e.g., 2G and 3G wireless communication standards which correspond to, for example, Global System for Mobile communications (GSM) and Universal Mobile Telecommunication System (UMTS) respectively) is well known in the art.

Telecommunication network operators (e.g., SP 110) carefully deploy BTS/Node-B cell towers (e.g., 145A and 145B) in a systematic manner to provide as geographically large of a wireless coverage area and pilot signal boundary 115 as possible, while minimizing overlap between BTS/Node-B cell towers, and minimizing the overall number of BTS/Node-B cell towers 145 required. Another consideration is the amount of communications bandwidth required in a particular area. For example, a densely populated city center will require more bandwidth for the same geographically sized area than a sparsely populated rural area.

Pilot signal boundary 115A is established by pilot signal 116 of BTS/Node-B cell tower 145A and geographically encompasses buildings 120A, 120B, and 120C. Buildings 120 generally represent an end users' residence, office, shopping center, or other places and locations from which an end user may access wireless telecommunication services. Obviously, an end user need not be inside a building to utilize a mobile device on SP's 110 network. Building 120E is shown outside of pilot signal boundary 115A and outside of wireless coverage range provided by BTS/Node-B cell tower 145A. Accordingly, building 120E will suffer from very poor network connectivity, or have no access to SP's 110 network, as the pilot signal boundaries 115A and 115B are insufficient to reach the mobile devices operating from the location of building 120E.

BTS/Node-B cell tower 145B and its corresponding pilot signal 116 establish pilot signal boundary 115B which advertises a wireless coverage area associated with BTS/Node-B cell tower 145B to mobile devices within pilot signal boundary 115B. Building 120D is located within pilot signal boundary 115B, and is further encompassed by pilot signal boundary 130 established by access point 135. The pilot signal boundary 130 provided by access point 135 is shown deployed in a location that is completely within an area having wireless coverage provided by conventional network infrastructure (e.g., the area within pilot signal boundary 115B). Access point 135 could similarly be deployed at building 120E, thus creating a pilot signal boundary 130 for the building's 120E location which otherwise lacks sufficient access to SP's 110 network by conventional means.

Pilot signal boundaries 115 provided by BTS/Node-B cell towers 145 and pilot signal boundary 130 provided by access point 135 each advertise the presence of a corresponding BTS/Node-B cell tower or access point, notifying mobile devices operating within range of the pilot signal boundary that an entry point to the network 100 is available.

Access point 135 is shown communicably interfaced with SP 110 via private backhaul 125, through private internet carrier 155. Rather than utilizing a data interface paid for and operated by SP 110, as is done by conventional BTS/Node-B cell towers 145A and 145B, access point 135 communicates with service provider 110 via a regular internet connection (e.g., private IP based backhaul 125), such as a Digital Subscriber Line (DSL), Fiber Optic connection (e.g., such as those offered by Verizon FiOS™), or a cable internet connection (e.g., such as those offered by Comcast™) provided by a private internet carrier 155. Internet connections such as these are commonplace in most residences, businesses, and commercial properties, and are adequate for transmitting telecommunication data between access point 135 and service provider 110. In some embodiments, Quality of Service (QoS) parameters may be employed to guarantee a minimum acceptable level of performance on private backhaul 125 by marking and giving priority to packets associated with access point 135.

An access point as referred to herein may be, for example, a “pico cell” base station or alternatively, a “femto cell” base station. A pico cell base station provides a short-range wireless coverage area via an antenna operating with limited power and communicates with a remote Base Station Controller (BSC) typically connected via twisted pair, ISDN connection, or Ethernet. Such a BSC typically manages multiple pico cells, and routes wireless communication traffic from the pico cell onto a backhaul internet connection for transmission to a centralized service provider. A femto cell base station (sometimes also referred to as a “Home Node-B” (HNB)) likewise provides a short-range wireless coverage area via an antenna operating under limited power, typically provides services for a smaller number of user devices compared with conventional network infrastructure cell towers, but includes additional functionality beyond that of a pico cell to route wireless communication traffic to its destination (e.g., a mobile device wirelessly interfaced with the femto cell or to a remote source communicatively interfaced with the femto cell).

Mobile devices 150A and 150B communicate wirelessly with BTS/Node-B cell towers 145A and 145B via air interface 140. Similarly, mobile device 150B communicates with access point 135 via air interface 140. Air interface 140 represents the wireless communication signals, protocols, and interface between the BTS/Node-B cell towers 145 and mobile devices 150 and between access point 135 and mobile devices 150.

Mobile device 150A is shown near the outside perimeter of both pilot signal boundary 115A and pilot signal boundary 115B, and is depicted to be in communication with both BTS/Node-B cell tower 145A and BTS/Node-B cell tower 145B. As mobile device 150A moves away from BTS/Node-B cell tower 145A and toward BTS/Node-B cell tower 145B, it eventually encounters pilot signal boundary 115B associated with BTS/Node-B cell tower 145B. When this or other conditions occur, the network 100 initiates a handoff of a wireless communication session associated with mobile device 150A from BTS/Node-B cell tower 145A to BTS/Node-B cell tower 145B. Other conditions may include the mobile device 150A encountering a subsequent pilot signal, determining that a traffic load, or the number of active calls, exceeds a threshold, or other conditions as well understood in the art. The handoff is seamless from the perspective of mobile device 150A, and once the handoff is complete, mobile device 150A communicates with BTS/Node-B cell tower 145B to access network 100 services rather than BTS/Node-B cell tower 145A. Mobile device 150A could, however, again move toward pilot signal boundary 115A associated with BTS/Node-B cell tower 145A, and another handoff would occur, this time back to BTS/Node-B cell tower 145A or be directed to transition back to BTS/Node-B cell tower 145A based on other conditions.

Similarly, mobile device 150B is shown completely interior to pilot signal boundary 115B associated with BTS/Node-B cell tower 145B, however, mobile device 150B is near the pilot signal boundary 130 associated with access point 135. As mobile device 150B nears pilot signal boundary 130 associated with access point 135, the network 100 will coordinate a handoff from BTS/Node-B cell tower 145B to access point 135. If mobile device 150B moves away from access point 135 and outside of an operational wireless coverage area provided by access point 135, mobile device 150B will re-encounter pilot signal boundary 115B (or the wireless coverage area that corresponds with pilot signal boundary 115B) associated with BTS/Node-B cell tower 145B, and the network will coordinate a handoff back to BTS/Node-B cell tower 145B.

Mobile device 150 may be a conventional cell phone compatible with one or more wireless communication protocols (e.g., UMTS, GSM, CDMA, etc.), or may be a wireless handheld device, such as a Personal Digital Assistant (PDA), a smart phone, a laptop computer or PC enabled to communicate with wireless networks (e.g., through a wireless network access card), or other electronic device capable of sending and receiving data or voice information via wireless communication networks.

Access point's 135 pilot signal boundary 130 is geographically small compared with that of pilot signal boundaries 115A and 115B associated with BTS/Node-B cell towers 145A and 145B. For example, pilot signal boundary 130 may be geographically limited to a house, office building, shopping mall, apartment building etc. Through the use of multiple access points, pilot signal boundary 130 may be expanded to larger areas such as a university or corporate campus. Nevertheless, such implementations are still geographically small in comparison to a conventional BTS/Node-B cell tower's pilot signal boundary 115 which may cover several city blocks or hundreds of acres in rural areas.

When a pilot signal boundary (e.g., 115A, 115B, or 130) overlaps with another pilot signal boundary, in whole or in part, the overlapping pilot signal boundary may create one of several signal interference conditions. For example, the overlapping pilot signal boundary may cause mobile devices 150 within range of the multiple pilot signal boundaries to repeatedly “hop” back and forth between two or more overlapping access points (e.g., 135) or conventional BTS/Node-B cell towers 145A and 145B. Repeated hopping can cause wasteful transactional overhead on the network and may cause a mobile device to connect with a network BTS/Node-B cell tower or access point that is less efficient than another available resource (e.g., further away, requiring additional battery power to transmit a wireless signal). Worse yet, overlapping pilot signal boundaries, in some situations, can cause mobile devices to be denied access altogether when a first BTS/Node-B cell tower (e.g., 145A or 145B) and an access point 135 essentially both refuse to grant access to the mobile device or to several mobile devices operating within the overlap area.

To minimize interference caused by overlapping pilot signal boundaries, it is necessary to calibrate the power level at which an access point 135 broadcasts its pilot signal, so that a resulting pilot signal boundary 130 is limited to its intended use area, such as the general geographic footprint of building 120D.

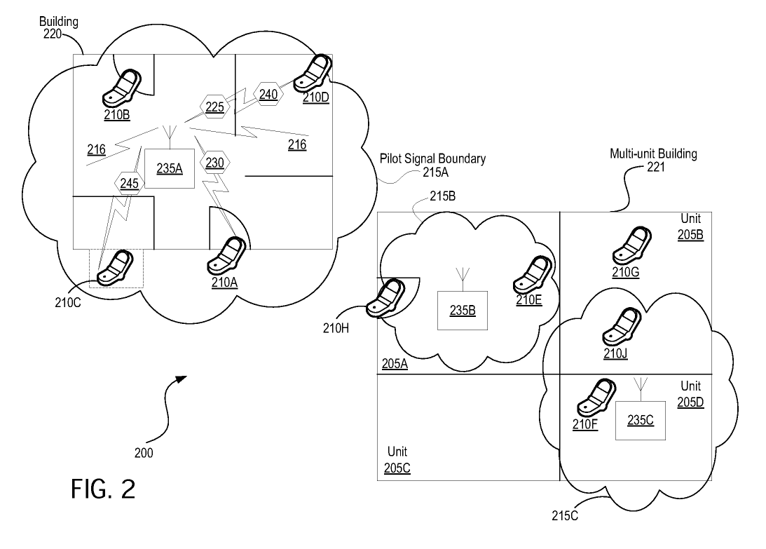

FIG. 2 is an alternative view of an exemplary network architecture 200 in which embodiments of the present invention may operate. Access point 235A provides wireless coverage for building 220 and establishes pilot signal boundary 215A, shown calibrated to encompass building 220. Interior to building 220 are mobile devices 210A, 210B, 210C, and 210D representing various specified locations within building 220. In particular, mobile device 210A is positioned at a front door or entry way of building 220, mobile device 210B is positioned at a back door of building 220, mobile device 210C at a driveway of building 220, and mobile device 210D at a location within building 220 approximately furthest from access point 235A (e.g., a potentially “worst case” location within building 220).

Similarly, multi-unit building 221 is depicted as having four separate units (e.g., apartments, rooms, offices, etc.). Specifically, unit 205A is shown with access point 235B providing a calibrated pilot signal boundary 215B. Mobile device 210H is within communication range of access point 235B (e.g., within pilot signal boundary 215B) and located at a front door or entry way of unit 205A. Mobile device 210E is likewise within communication range of access point 235B and positioned at a wall within unit 205A adjoining a neighboring unit (e.g., unit 205B) within multi-unit building 221. Unit 205B does not have an access point, but shows mobile device 210G and 210J within unit 205B. Mobile device 210G is unaffected by access point devices within neighboring units, however, mobile device 210J may be negatively affected by signal interference originating from access point 235C in neighboring unit 205D. Unit 205C is shown empty, and unit 205C is shown with access point 235C which is improperly calibrated and is generating a pilot signal boundary 215C that is encroaching into units 205A, 205B, and 205C. Mobile device 210F is located within unit 205D.

Depending on the type of location and objectives of a service provider, access point pilot signal boundaries 215 may be automatically calibrated to accommodate different objectives. For example, a service provider may desire to minimize the size of a pilot signal boundary 215 if, for example, the corresponding access point 235 is deployed within a high density urban area where any potential pilot signal boundary overlap may negatively affect wireless communications for mobile devices 210 not intended to communicate with the access point 235. The service provider may also desire to minimize the size of a pilot signal boundary 215 if, for example, the service provider does not want to allow service subscribers to benefit from enhanced services or preferred billing rates outside of a designated area, such as building 220 where the access point 235 is deployed.

Conversely, service subscriber consumers are likely to want as broad as a pilot signal boundary 215 as possible, so that their mobile devices handoff to the access point 235 as soon as possible, thus allowing for access to enhanced services and preferred billing rates.

Through variation of pilot signal power levels within an access point 235, a pilot signal boundary 215 can be automatically calibrated to an appropriate size based on an actual operational environment in which the access point 235 is deployed, and base further on objectives of the service provider and service subscriber (e.g., an end-user).

In one embodiment, access point 235A may initiate an automated calibration routine based on an event. For example, access point 235A may receive a calibration request from a service provider communicatively interfaced via a backhaul interface or initiate an automated calibration routine based upon a local event, such as an initial boot up of an access point (e.g., a first boot up after manufacture), based upon receiving a master reset instruction (e.g., via a manufacturer's reset button on an integrated control panel of the access point), or based on a remote request from a mobile device 215 communicatively interfaced with the access point.

In one embodiment, pilot signal boundary 215A associated with access point 235A is automatically calibrated to nearly fully encompass building 220. Access point 235A instructs a mobile device to locate to a first position and send an acknowledgement to access point 235A when a pilot signal is received at that first position.

For example, access point 235A may instruct mobile device 210A to locate to the front door of building 220. In one embodiment, access point 235A sends mobile device 210A relocation prompt 230 (e.g., a relocation request), requesting that mobile device 210A locate to a specified position (e.g., a front door of building 220 if such a location is where a properly calibrated pilot signal should be first encountered).

In one embodiment, access point 235A automatically sets an operational pilot signal power level, thus establishing a properly calibrated pilot signal boundary without human intervention, while an untrained service subscriber (e.g., an end-user) physically relocates mobile device 210A to a specified location (e.g., building location 210A) as directed by access point 235A. Use of the untrained service subscriber to physically relocate the mobile device while the access point automatically performs pilot signal calibration routines, without intervention by a trained technician, may reduce the overall costs of deployment for the access point.

Relocation prompt 230 may be an audible message, a text prompt, an Short Message Service (SMS) based text message, an application interface prompt or message, or any other communication from access point 235 to a mobile device 210. Some mobile devices, such as “smart phones” and many cellular phones further support mobile applications based on wireless programming languages, and are capable of interacting with application interface messages. Common wireless programming languages include Object Oriented Programming (OOP) for mobile applications, such as a JAVA™ compatible mobile application, as well as Wireless Application Protocol (WAP), Wireless Markup Language (WML), Binary Runtime Environment for Wireless (BREW), and other structured programming based constructs. If the mobile device 210 supports a compatible mobile application, the access point 235A can originate an application interface message and transmit relocation prompt 230 to the mobile application executing in the mobile device (e.g., via a JAVA™ based application servlet interface message, an Application Programming Interface (API), or a mobile application messaging interface). Mobile devices 210 that support mobile applications would then, upon receiving relocation prompt 230 display relocation prompt 230 at a user interface integrated with the mobile device or audibly transmit the relocation prompt via an integrated speaker.

In some embodiments, access point 235 may determine whether or not a mobile device 210 supports, or is compatible with a mobile application. For example, access point 235 may attempt to initiate communications with a mobile application messaging interface at the mobile device, and based on a response (e.g., an error message, no response, an acknowledgement, etc.), the access point may determine that the mobile device does or does not support mobile applications.

In some embodiments, if the mobile device 210 does support mobile applications, the access point 235 will deploy a mobile application to the mobile device 210 via mobile application deployment package 245. For example, the access point 235 may perform a remote install of the mobile application, if supported, or merely send the mobile application deployment package 245 to the mobile device 210 with instructions for the mobile device 210 to install the mobile application deployment package 245. In some embodiments, the mobile application deployment package 245 is marked as a “trusted” or “secure” deployment package, as it is provided by a service provider (e.g., a telecommunications provider on which mobile device 210 operates), and thus, is required to conform with a minimum set security and compatibility requirements.

In some embodiments, the mobile application deployment package 245, once installed, executes as a mobile application at the mobile device 210, and is used to transact communication messages between the access point 235 and the mobile device 210, for example, messages including relocation prompt 230, relocation confirmation 225, and pilot signal acknowledgement 245.

If a mobile device (e.g., 210A) does not support mobile applications, access point 235 may transmit relocation prompt 230 to mobile device 210A via a Short Message Service (SMS) message generated at the access point or other compatible text messaging protocol. For example, access point 235 may send mobile device 210A an SMS based text message stating, for example, “Please relocate to the front door for access point calibration.”

If a mobile device (e.g., 210A) does not support either mobile applications or SMS based text messaging, access point may transmit relocation prompt 230 to mobile device 210A via a telephony based voice call (e.g., a phone call) originating at access point 235A and terminated at mobile device 210A. For example, access point 235A may initiate a voice call to the mobile device and upon establishing a connection, audibly transmit a pre-recorded or synthesized voice message to mobile device 210 requesting the mobile device to relocate to a specified position (such as the front door) for the purpose of access point calibration. For example, upon establishing a connection, the access point may transmit computer generated speech stating, “Please relocate to the front door for access point calibration.”

In addition to requesting a mobile device to relocate to a specified position, relocation prompt 230 may further request that a mobile device (e.g., 210A) confirm or acknowledge that it is at the specified location. For example, access point 235A may send relocation prompt 230 requesting the mobile device to relocate to a specified position and send a responsive message upon arrival. Similar to above, such instructions to relocate and send a responsive message may be sent via an application interface message (e.g., an application interface message), an SMS based text message, or an audible transmission via a voice call.

In one embodiment, a mobile device (e.g., 210D) sends relocation confirmation 225 to access point 235A upon relocating to a specified position or location responsive to a relocation prompt (e.g., 230) received at the mobile device. For example, mobile device 210D is shown relocating to a location within building 220 that is approximately furthest in distance from access point 235A. Access point 235A may have instructed mobile device 210D to locate to the position shown and acknowledge it is at that location via a responsive relocation confirmation message 225.

Similar to above, communications between access point 235A and mobile devices (e.g., 210D) may take the form of application interface prompts, SMS based text messages, or voice telephony calls. For example, in the case of application interface prompts, mobile device 210D may transmit relocation confirmation 225 to access point 235A by pressing an icon displayed at the mobile device by an application executing within the mobile device and communicating with the access point. For example, relocation prompt 230 may display a graphical prompt at the mobile device (e.g., 210D) stating, “Please relocate to a position furthest away from the access point, and click the ‘O.K.’ button when at the specified position.” In such a case, the message to “Please relocate to a position . . . ” would represent relocation prompt 230, and the “O.K.” button displayed, would trigger an application executing in the mobile device to transmit relocation confirmation 225 to access point 235A when pressed or clicked.

If mobile device 210D does not support mobile applications, an SMS message may be transmitted to access point 235A upon arriving at a specified location responsive to relocation prompt 230, providing the relocation confirmation 225. For example, access point 235A may send an SMS message stating, “Please relocate to [a specified location] . . . and send a return SMS message to ‘12345’ upon relocating to the specified location.” As above, the message to “Please relocate to . . . ” would be the relocation prompt 230 sent via SMS, and a responsive message sent to ‘12345’ would constitute a relocation confirmation 225 from mobile device, indicating the mobile device has relocated to the specified position or location.

If mobile device 210D does not support either mobile applications or SMS based text messaging, relocation confirmation 225 may be provided (e.g., transmitted from mobile device 210D to access point 235A) via a telephony voice call (e.g., a phone call). For example, if access point 235A originates a telephone call to mobile device 210D and prompts mobile device 210D to relocate to a specified position via an audible message, mobile device 210D may provide relocation confirmation 225 to access point 235A via Dual Tone Multiple Frequency (DTMF) tones transmitted over the telephony voice call (e.g., by pressing, for example, “# #” or some other number sequence on a telephone keypad), or by audibly transmitting human speech from the mobile device back to the access point, at which the access point may use speech recognition to interpret the human speech. If the telephony voice call is no longer active because the access point terminated the voice call after prompting the mobile device to relocate, then mobile device 210D may originate a telephone call back to access point 235A, by calling a particular telephone number or number sequence (e.g., “*12345”) which represents relocation confirmation 225 to the access point.

In one embodiment, access point 235A transmits a pilot signal 216 at a default power level, and at increasing power level increments (e.g., increasingly elevated or graduated power levels or increasing power level stages or steps) responsive to receiving relocation confirmation 225, and continues transmitting the pilot signal 216 at increasing power level increments until a pilot signal acknowledgement 240 is received from a mobile device (e.g., 210D). For example, access point 235A may, upon receiving relocation confirmation 225 indicating that a mobile device has relocated to a specified position, begin broadcasting pilot signal 216 at a minimum power level (or at some higher power level based on configuration parameters) and repeatedly check for a pilot signal acknowledgement 240 from mobile device 210 then increase the pilot signal 216 power level and check again for a pilot signal acknowledgement 240, and so on, until either the pilot signal 216 is transmitted at a maximum allowable power setting or a pilot signal acknowledgement 240 is received from mobile device 210 indicating the pilot signal 216 was received at the mobile device from the specified location. Alternatively, the mobile device may establish a wireless communication session with the access point 235A by physically locating within or adjacent to the pilot signal boundary 215A associated with the access point 235A, and then cooperatively adjust transmit power levels between the mobile device and the access point until relocated to the specified position.

Pilot signal acknowledgement 240 may be an automated response or a manually triggered response. For example, some mobile devices 210 may have logic or application functionality allowing the mobile device 210 to detect the presence of a pilot signal 216 and automatically trigger the transmission of a pilot signal acknowledgement 240 responsive to receiving (e.g., detecting) the pilot signal 216. Mobile devices that are in communication with the access point via an active wireless communication session may utilize a manually triggered response designed to indicate the transmit power level adjustment in place at the time the pilot signal is received (e.g., measured or detected) from the specified location.

Other mobile devices 210 may not be compatible with automated triggering functionality, and thus, may require a manual event at the mobile device to trigger the transmission of a pilot signal acknowledgment 240 that is not part of an active wireless communication session.

Similar to a relocation confirmation 225, pilot signal acknowledgments 240 may be sent via applications operating at a mobile device 210 (e.g., via a application messaging interface from the mobile device), via an SMS message which is sent from a mobile device 210 responsive to receiving or detecting a pilot signal 216, or via a voice telephone call that is already active between the access point 235 and the access point or a new voice telephone call that originates at the mobile device 210 and terminates at the access point 235.

When access point 235 receives the pilot signal confirmation 240 from mobile device 210, it records the power level at which the pilot signal was transmitted when the confirmation was received. The recorded power level value for the pilot signal 216 represents a minimum value at which a mobile device 210 is capable of detecting the pilot signal 216 at the specified location. A power level for an operational pilot signal used to establish a calibrated pilot signal boundary 215 may be higher or lower or identical, depending on what parameters are considered and how those parameters are prioritized.

Parameters that may be considered in establishing an operational pilot signal power level may include, for example, measured power level readings recorded from within the mobile device at the specified location or from any number of subsequent specified locations, captured by repeating the process of sending a relocation prompt 230 to mobile device 210, receiving a relocation confirmation 225 from mobile device 210, transmitting the pilot signal 216 at ever increasing power levels or increments until a pilot signal acknowledgement 240 is received, and recording the corresponding pilot signal power level as a measured pilot signal power level for the specified location. The measured power level may also represent the current transmit power level adjustment in place for an active wireless communication session between the mobile device and the access point.

In one embodiment, the parameters used in establishing the operational pilot signal power level may be used to configure an electronically “steereable” antenna or antenna array at the access point, affecting the resulting shape of a transmitted signal's coverage area (e.g., the shape of the area covered by pilot signal 116). For example, a non-steerable antenna signal may represent a basic omni-directional or “donut shaped” signal pattern. Such a pattern may be adequate in some areas of a building or structure, but may not be strong enough to reach more distant or obstructed areas of the same building. Conversely, an electronically steerable antenna may be configured to broadcast a more elliptical shaped signal pattern in a preferred directionality which emphasizes signal strength in, for example, a more distant or obstructed area of a building and deemphasizes areas nearer to the access point which require lower transmit power levels. Varied techniques for configuring an electronically steerable antenna or antenna array are well understood in the art. For example, one such approach includes broadcasting a base signal via a first antenna and then broadcasting the signal again after a 90 degree phase delay from a second antenna in the same steerable antenna array.

Various specified locations that may be taken into account are countless, but likely locations of interest may include, for example, a front door or entry way, a drive way, a back door, a potential worst case location within a building, and a wall that separates two apartment units, one of which is associated with an access point 235, the other having no association with the access point 235. In the case of a private residence, an ideal location for a mobile device (e.g., 210A) to encounter a pilot signal boundary 215A and thus trigger a handoff to an access point 235A associated with the pilot signal boundary 215A may be, for example, a front door or a driveway, and thus, measured pilot signal power levels at such locations may be given a high bias, to prejudice the pilot signal boundary 215A toward reaching those locations.

Further parameters that may be considered are, for example, a pilot signal boundary 215 bias that conservatively calculates appropriate pilot signal power levels (e.g., for deployments in dense urban environments where pilot signal overlap may be considered more harmful) or a pilot signal boundary 215 that calculates more liberal pilot signal power levels (e.g., for rural and suburban operational environments where overlap may be less likely to occur). Moreover, access point 235 may receive signal quality metrics from the mobile device 210 indicating the quality of the pilot signal, as measured at the mobile device itself, which may be a separate value than the pilot signal power level recorded when pilot signal acknowledgement 240 is received at the access point 235.

Signal quality metrics may include further characteristics of the pilot signal or a wireless communication session signal useful in objectively measuring the robustness of a wireless signal. For example, signal quality metrics may include particular attributes that are measurable from within the mobile device itself including a “Bit Error Ratio” (BER) representing a ratio of the number of bits, elements, characters, or blocks incorrectly received to the total number of bits, elements, characters, or blocks sent during a specified time interval, a “Signal-to-Noise-Ratio” (SNR) representing the ratio of a signal's transmit power level to the amount of noise (e.g., interference) corrupting the signal, and a “Received Signal Strength Indication” (RSSI) representative of the power present in a radio signal received at the mobile device, typically before local amplification or restoration of the received signal.

In some embodiments, access point 235 may perform validation on relocation confirmation 225 messages to ensure the integrity an accuracy of a responsive relocation confirmation 225 indicating that a mobile device 210 is indeed at a specified location. For example, access point 235 may request that mobile device 210 transmit a digital photograph of the specified location with the relocation confirmation 225, upon which, access point 235 may run validation routines (e.g., performing digital processing on the photograph looking for common or predictable objects, such as a front door, a driveway, a patio, and so forth).

Upon recording measured pilot signal power levels from the necessary locations, access point 235 then sets an operational pilot signal power level (e.g., a power level for ongoing or normal usage), thus establishing a calibrated pilot signal boundary 215A.

Pilot signal boundary 215A which mostly surrounds building 220 depicts what may be a properly calibrated pilot signal boundary 215A for a suburban or rural private residence, for a commercial shopping area with an access point open to patrons, or for a small office building with an access point open to employees. However, a pilot signal boundary 215A that exceeds a physical building's physical structure may not be appropriate in all situations. For example, pilot signal boundary 215C encompasses unit 205D of multi-unit building 221 providing adequate coverage for mobile device 210F within unit 205D, however, the pilot signal boundary 215C encroaches significantly into unit 205B of the same multi-unit building 221. Pilot signal boundary 215C overlaps into unit 205B, potentially causing negative signal interferences for mobile device 210J located near the bottom of unit 205B within range of pilot signal boundary 215C, while mobile device 210G near the top of unit 205B is shown out of range, and thus likely unaffected by the overlapping pilot signal boundary 215C.

Pilot signal boundary 215B represents an appropriately calibrated operational pilot signal power level for access point 235B within unit 205A of multi-unit building 221. Pilot signal boundary 215B adequately covers nearly all of the space associated with unit 205A, without overlapping into adjoining or adjacent units in the same multi-unit building 221, and thus negatively affecting wireless communications potentially taking place in those units (e.g., neighboring and diagonally located units 205B, 205C, and 205D). In particular, mobile devices 210H and 210E within unit 205A will encounter pilot signal boundary 215B and remain within the pilot signal boundary 215B at both the front door of unit 205A and at a far wall of unit 205A that adjoins neighboring unit 205B, without negatively affecting mobile devices operating in other units via an improperly calibrated and overlapping pilot signal boundary, such as that associated with unit 205D.

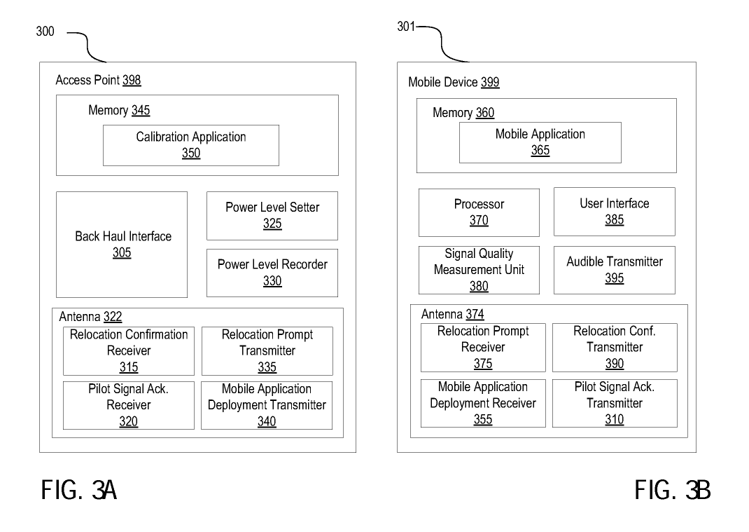

FIG. 3A is a diagrammatic representation 301 of an access point 398 for sending a relocation prompt to a mobile device and receiving a pilot signal acknowledgement from the pilot device, in accordance with one embodiment of the present invention. Access point 398 is shown with many components, some of which are optional in some embodiments.

Memory 345 provides volatile and non-volatile storage capabilities within access point 398. Memory may include Random Access Memory (RAM) or equivalent operational memory, and may further include permanent storage, such as Read Only Memory (ROM), Non-Volatile Random Access Memory (NVRAM), Flash memory, Hard Disk Drive (HDD) storage, optical storage, and so forth. Memory 345 contains calibration application 350 which may execute with the aid of a Central Processing Unit (CPU) and reside in volatile memory to perform automated calibration routines. Memory 345 may further include mobile application deployment packages, relocation prompts, and relocation confirmation validation software.

Application 345 may provide an Application Programming Interface (API) or a message interface with which to send and receive application messages and prompts to a corresponding application executing in a mobile device (such as a deployed mobile application). APIs and message interfaces may include Short Message Service (SMS) message capabilities, remote application prompts, HTML based web traffic, and so forth.

Backhaul interface 305 provides a communication interface to a private internet connection and thus, a communications interface back to a service provider. Power level setter 325 sets pilot signal power levels in both operational (e.g., ongoing) mode and in calibration mode. Power level setter 325 may set pilot signals to a particular power level to be maintained for a long period of time in operational mode or may repeatedly set pilot signal power levels to varying signal strengths during a calibration routine. Power level recorder 330 records power level settings within access point 398 when a pilot signal acknowledgement is received from a mobile device indicating that the mobile device received or detected the pilot signal at a location specified by the access point 398. Power level recorder 330 further records signal quality metrics and measurements received from compatible mobile devices (e.g., a pilot signal power level as measured at the mobile device rather than as measured at the access point upon receiving a pilot signal acknowledgement).

Antenna 322 associated with access point 398 includes relocation confirmation receiver 315, relocation prompt transmitter 335, pilot signal acknowledgement receiver 320, and mobile application deployment transmitter 340. Relocation confirmation receiver 315 receives relocation confirmation messages from mobile devices which are sent responsive to relocation prompts instructing the mobile device to relocate to a specified position. Relocation prompt transmitter 335 sends the relocation prompts to mobile devices, as instructed by calibration application 350 executing a pilot signal boundary calibration routine.

Pilot signal acknowledgement receiver 320 receives pilot signal acknowledgements from mobile devices which indicate that a mobile device has received a pilot signal transmitted from the antenna 322 associated with access point 398.

FIG. 3B is a diagrammatic representation 301 of a mobile device 399 for receiving a relocation prompt from an access point and sending a pilot signal acknowledgement to the access point, in accordance with one embodiment of the present invention. Mobile device 399 is shown with many components, some of which are optional in some embodiments.

Memory 360 provides volatile and non-volatile storage capabilities within mobile device 399. Memory may include RAM or equivalent operational memory, and may further include permanent storage, such as ROM, NVRAM, HDD storage, optical storage, and so forth. Memory 360 contains mobile application 365 which may provide an API and messaging interface to remote applications, such as calibration application 350 executing in access point 398, and participate in calibration routines choreographed by access point 398.

Processor 370 provides execution capabilities and memory access services for mobile application 365. User interface 385 provides a graphical or textual based interface with which an end user may interact with mobile device 399 and mobile application 365 executing thereon. User interface 385 may further display application prompts and messages generated locally or received remotely (e.g., from access point 398), such prompts and messages may include relocation prompts, or instructions accompanying a mobile application deployment package. Moreover, user interface 385 may be used to initiate the transmission of messages to access point 398, such as relocation confirmation messages and pilot signal acknowledgement messages.

Audible transmitter 395 (e.g., an integrated speaker) audibly transmits or plays voice streams, audible messages, beeps, or tones generated at the mobile device 399 via mobile application 365 or received via application interface prompts or messages from a calibration application executing in access point 398. Signal quality measurement unit 380 measures various characteristics of a detected pilot signal at the mobile device and packages the signal quality metrics for transmission to an access point 398 via antenna 374 of the mobile device 399. Such signal quality characteristics may be utilized in the calibration of a pilot signal boundary or in later adjustments to such a pilot signal boundary.

Antenna 374 includes relocation prompt receiver 375, relocation confirmation transmitter 390, mobile application deployment receiver 355, and pilot signal acknowledgement transmitter 310. Relocation prompt receiver 375 receives relocation prompts and messages originating from the calibration application 350 executing in access point 398. Relocation confirmation transmitter 390 sends relocation confirmations to the access point 398 indicating that the mobile device 399 has relocated to a location specified by the access point 398 as part of a calibration routine. Mobile application deployment receiver 355 receives mobile application deployment packages for installation and execution at mobile device 399, resulting in mobile application 365 executing in mobile device 399. Pilot signal acknowledgment transmitter 310 sends an acknowledgement message to the access point 398 indicating that the mobile device 399 has detected a pilot signal from the access point 398.

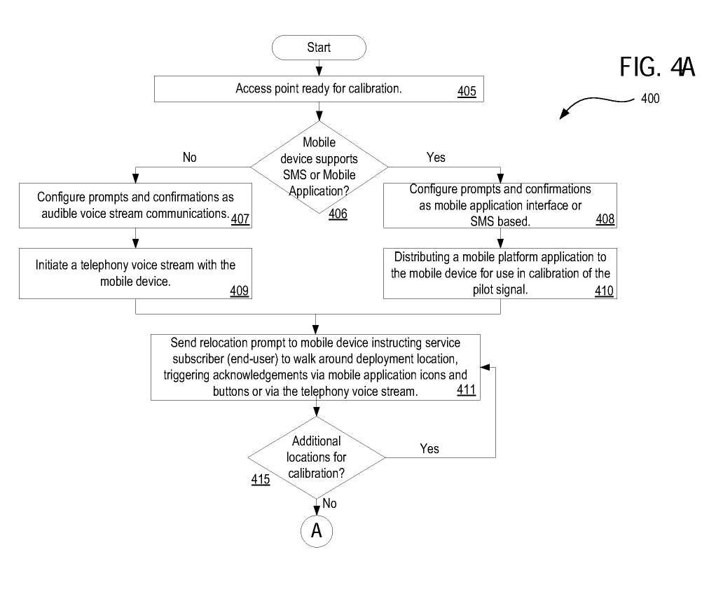

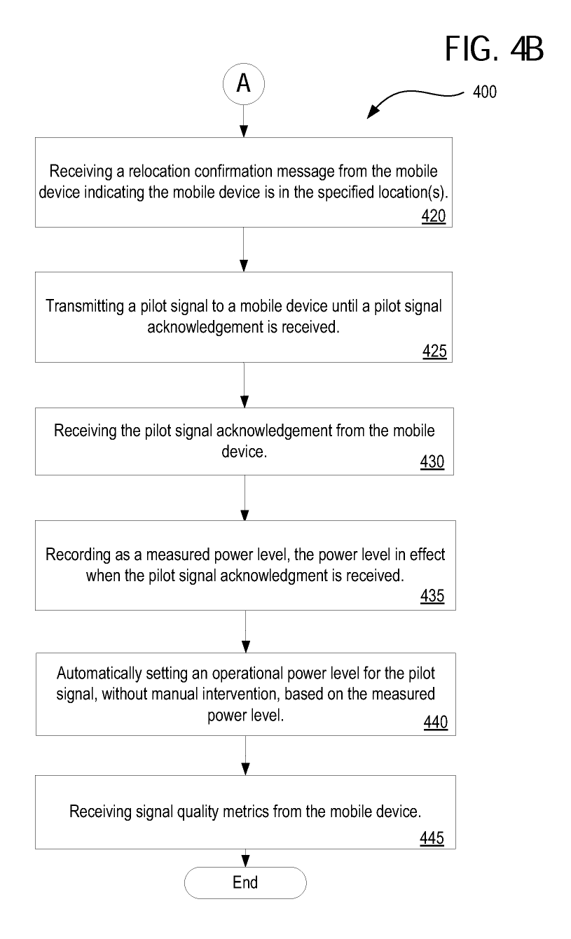

FIG. 4A and FIG. 4B are flow diagrams illustrating a method 400 for sending a relocation prompt to a mobile device and receiving a pilot signal acknowledgement from the pilot device, in accordance with one embodiment of the present invention.

Method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, method 500 is performed by a computing device, such as access point 135 of FIG. 1.

Referring to FIG. 4A, method 400 begins with processing logic in an access point communicably interfaced with a telecommunications network, the access point is in a state ready for calibration (block 405). For example, the access point may ready itself for calibration responsive to receiving a request to initiate calibration of a pilot signal from a service provider, a mobile device, or based on an event within the access point itself, such as responding to a service subscriber pressing a calibration button on a control panel integrated with the access point.

At decision point 406, the access point determines whether the mobile device supports SMS or mobile applications. If the mobile device does not support a compatible mobile application, method 400 proceeds along the “No” branch to block 407. At block 407, the access point configures prompts and confirmations (e.g., relocation prompts, pilot signal acknowledgements, relocation confirmations, etc.) as audible voice stream communications via a telephony voice stream (e.g., a phone call). At block 409, the access point initiates a telephony voice stream with the mobile device over which to communicate prompts and confirmations used during the calibration process.

If, at decision point 406, the access point determines the mobile device does support mobile application, method 400 proceeds along the “Yes” branch to block 408. At block 408, the access point configures prompts and confirmations (e.g., relocation prompts, pilot signal acknowledgements, relocation confirmations, etc.) as mobile application interface or SMS based prompts and confirmations. At block 410, processing logic in the access point distributes a mobile platform application to the mobile device via a wireless interface (e.g., via an Over The Air (OTA) interface) to the mobile platform application for use in calibration of the pilot signal.

At block 411, processing logic in the access point sends a relocation prompt to the mobile device instructing the mobile device to relocate to a specified location. The relocation prompt is sent by the access point via one of: an application message directed at the mobile application, a text message over SMS, or an audible message over a voice telephony link. For example, in one embodiment, the access point instructs a service subscriber or end-user to walk around a private residence to various locations, triggering acknowledgements via icons and buttons displayed on a mobile application user interface executing on the mobile device. In another embodiment, the service subscriber triggers acknowledgements via the mobile device over a end-to-end telephony voice stream with the access point by speaking into the mobile device or by transmitting DTMF based tones through the mobile device (e.g., by pressing number keys on a keypad of the mobile device).

At decision point 415, the access point determines whether additional locations are required from which to determine minimum pilot signal power levels for use in automated calibration of the access point. If the access point determines additional locations for calibration are required, method 400 loops back to block 411, and sends subsequent relocation prompts to the mobile device. If the access point determines that additional locations for calibration are not required, method 400 proceeds instead to block 420 of FIG. 4B via connector “A.”

FIG. 4B is a continuation flow diagram illustrating method 400 from FIG. 4A, beginning with block 420, following connector “A” from FIG. 4A. At block 420, processing logic in the access point receives a relocation confirmation message from the mobile device via an application message, an SMS message, or over the voice telephony link. The relocation confirmation message indicates the mobile device is in the specified location as instructed by the relocation prompt.

At block 425, processing logic in the access point transmits the pilot signal to the mobile device operating in the specified location until a pilot signal acknowledgement is received from the mobile device indicating the pilot signal was detected at the specified location. In one embodiment, the mobile device must first establish a wireless communication session with the access point by entering the wireless signal boundary area associated with the access point, after which the mobile device and access point automatically adjust power levels to maintain the active wireless communication session, and the mobile device sends the pilot signal acknowledgement after arriving at the specified location. In one embodiment, the mobile device need not enter the wireless signal boundary area associated with the access point to first establish a wireless communication session, and the access point instead transmits the pilot signal to the mobile device using increasing power levels until the pilot signal acknowledgement is received. At block 430, the access point receives the pilot signal acknowledgement from the mobile device indicating the pilot signal was detected at the specified location.

At block 435, processing logic in the access point records the power level in effect when the pilot signal acknowledgment is received from the mobile device as a measured power level. The measured power level may represent the transmit power level of the pilot signal itself at the time the pilot signal acknowledgement is received, a transmit power level associated with an active wireless communication session between the access point and the mobile device at the time the access point receives the pilot signal acknowledgement, or a power level status from within the mobile device itself, returned with the pilot signal acknowledgement, indicating a transmit power level as measured from within the mobile device at the time the pilot signal acknowledgement is sent.

At block 440, processing logic in the access point automatically sets an operational power level for the pilot signal, without manual or human intervention, based on the measured power level increment at which the pilot signal was transmitted when the pilot signal acknowledgement was received. At block 445, the access point receives signal quality metrics from the mobile device indicating the quality of the pilot signal as measured at the mobile device. Processing logic in the access point then adjusts the operational pilot signal power level of the access point based on the signal quality metrics.

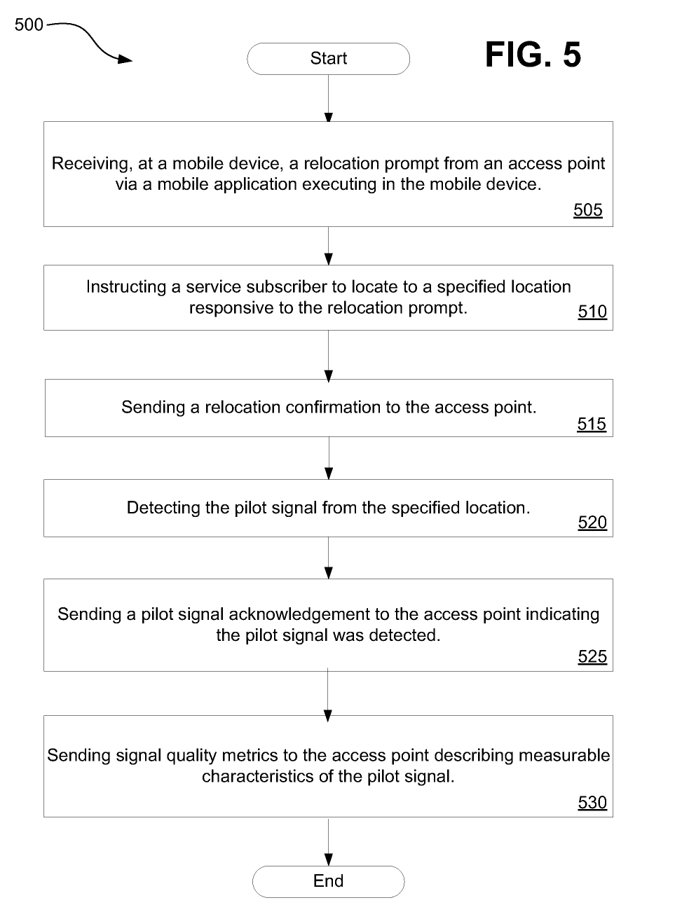

FIG. 5 is a flow diagram illustrating a method 500 for receiving a relocation prompt from an access point and sending a pilot signal acknowledgement to the access point, in accordance with one embodiment of the present invention.

Method 500 may be performed by processing logic that may include hardware (e.g., circuitry, dedicated logic, programmable logic, microcode, etc.), software (e.g., instructions run on a processing device to perform hardware simulation), or a combination thereof. In one embodiment, method 500 is performed by a computing device, such as mobile device 150A or 150B of FIG. 1.

Referring to FIG. 5, method 500 begins with processing logic in a mobile device communicably interfaced with an access point, the mobile device receives a relocation prompt from an access point via a mobile application executing in the mobile device, the relocation prompt instructs the mobile device to relocate to a location specified by the relocation prompt and acknowledge a pilot signal detected from the location specified (block 505).

At block 510, the mobile device instructs a service subscriber (e.g., untrained end-user) to locate to a specified position. In some embodiments, the service subscriber physically moves the mobile device to the specified location, responsive to the relocation prompt. At block 515, processing logic in the mobile device sends a relocation confirmation to the access point via the mobile application executing in the mobile device.

At block 520, processing logic in the mobile device detects the pilot signal from the location specified by the relocation prompt. At block 525, processing logic in the mobile device sends a pilot signal acknowledgement to the access point via the mobile application indicating the pilot signal was detected at the location specified.

At block 530, processing logic in the mobile device sends signal quality metrics to the access point via the mobile application executing in the mobile device. The signal quality metrics describe measurable characteristics of the pilot signal received at the location specified by the relocation prompt.

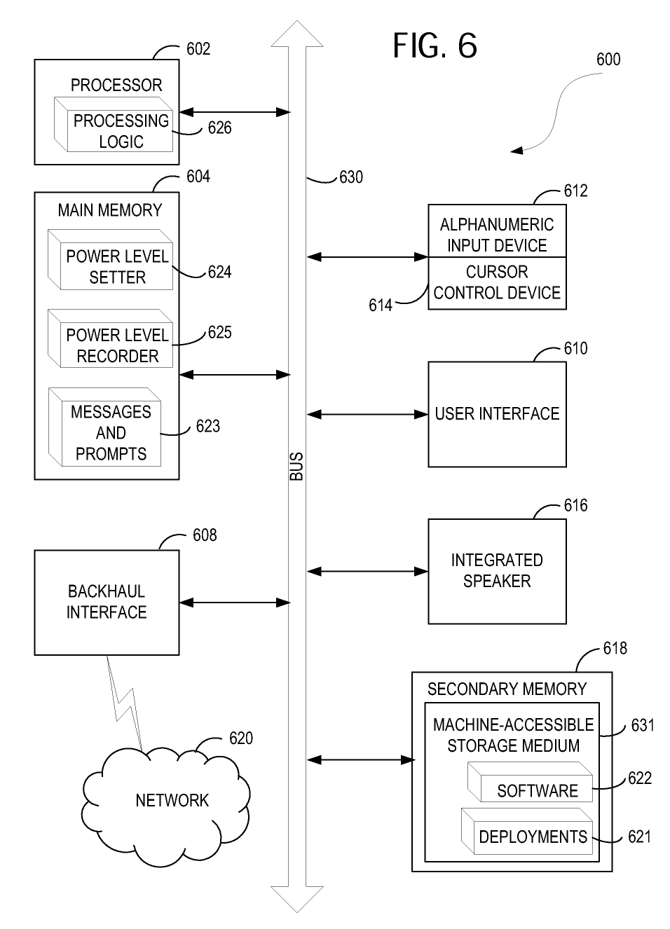

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processor 602, a main memory 604 (e.g., read-only memory (ROM), flash memory, dynamic random access memory (DRAM) such as synchronous DRAM (SDRAM), static memory, flash memory, static random access memory (SRAM), etc.), and a secondary memory 618 (e.g., a data storage device), which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the processing logic 626 for performing the operations and steps discussed herein.

The computer system 600 may further include a backhaul interface 608 (e.g., a network interface device). The computer system 600 also may include a user interface 610 (e.g., a liquid crystal display (LCD) or a cathode ray tube (CRT)), an alphanumeric input device 612 (e.g., a keyboard), a cursor control device 614 (e.g., a mouse), and an integrated speaker 616 for transmitting telephony voice streams and audible notifications (e.g., a signal generation device).

Main memory 604 may include, for example, power level setter 624 for automatically setting the power level of a pilot signal in either operational mode or in calibration mode, and power level recorder 625 for recording the broadcast power level of a pilot signal when a pilot signal acknowledgement is received indicating the pilot signal was received. Main memory 604 may further include messages and prompts 623 for transmission to mobile devices instructing or requesting the mobile devices to take a particular action (e.g., relocate to a specified location, acknowledge a pilot signal when detected, send a relocation confirmation, etc.). The secondary memory 618 may include a machine-readable storage medium (or more specifically a computer-readable storage medium) 631 on which is stored one or more sets of instructions (e.g., software 622) embodying any one or more of the methodologies or functions described herein, or deployments 621 (e.g., mobile application deployment packages for transmission to a mobile device to execute during calibration routines). The software 622 may also reside, completely or at least partially, within the main memory 604 and/or within the processing device 602 during execution thereof by the computer system 600, the main memory 604 and the processing device 602 also constituting machine-readable storage media. The software 622 may further be transmitted or received over a network 620 via the backhaul interface 608.

While the machine-readable storage medium 631 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having instructions stored thereon, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method in an access point, comprising:
transmitting a pilot signal to a mobile device operating in a specified location until a pilot signal acknowledgement is received from the mobile device indicating the pilot signal was detected at the specified location; and
automatically setting an operational power level for the pilot signal based on a power level at which the pilot signal was transmitted when the pilot signal acknowledgement was received.

2. The method of claim 1, further comprising:
receiving a request to initiate calibration of a pilot signal transmitted from the access point, the pilot signal establishing a pilot signal boundary advertising the presence of the access point to mobile devices within reception range of the pilot signal boundary.

3. The method of claim 2, wherein receiving the request to initiate calibration of the pilot signal comprises one of:
receiving the request from a service provider via a backhaul Internet Protocol (IP) line communicably interfaced with access point;
receiving the request from the mobile device via a wireless interface between the mobile device and the access point; and
receiving the request from a control panel integrated with the access point.

4. The method of claim 1, further comprising:
sending a relocation prompt to the mobile device instructing the mobile device to locate to the specified location; and
receiving a relocation confirmation message from the mobile device indicating the mobile device is in the specified location as instructed by the relocation prompt.

5. The method of claim 4, wherein:
transmitting the pilot signal to the mobile device until the pilot signal acknowledgement is received comprises:
establishing a wireless communication session with the mobile device;
adjusting transmit power levels to maintain the wireless communication session with the mobile device until the pilot signal acknowledgement is received; and wherein automatically setting the operational power level for the pilot signal based on the power level at which the pilot signal was transmitted when the pilot signal acknowledgement is received comprises automatically setting the operational power level for the pilot signal, without human intervention, based on the transmit power level adjustment in place at the time the pilot signal acknowledgement is received.

6. The method of claim 4, further comprising:
receiving the pilot signal acknowledgement from the mobile device indicating the pilot signal was detected at the specified location; and
recording the power level at which the pilot signal was transmitted when the pilot signal acknowledgment was received from the mobile device as a measured power level.

7. The method of claim 6, further comprising:
sending a second relocation prompt to the mobile device instructing the mobile device to locate to a second specified location, different than the first specified location;
receiving a second relocation confirmation message from the mobile device indicating the mobile device is in the second specified location as instructed by the second relocation prompt;
transmitting a second pilot signal to the mobile device operating in the second specified location until a second pilot signal acknowledgement is received from the mobile device;
receiving the second pilot signal acknowledgement from the mobile device indicating the pilot signal was detected at the second specified location;
recording the power level at which the second pilot signal was transmitted when the second pilot signal acknowledgment was received from the mobile device as a second measured power level; and wherein
automatically setting the operational power level for the pilot signal comprises automatically setting the operational power level for the pilot signal, without human intervention, based on the first and second measured power levels.

8. The method of claim 7, wherein the first specified location and the second specified location each comprise one of:
a front door of a residential premises;
a driveway of a residential premises;
a basement of a residential premises;
a location in a residential premises approximately furthest from the access point;
a location adjacent to a wall in a residential apartment unit separating the residential apartment unit from a second residential apartment unit; and wherein
the first specified location and the second specified location are different.

9. The method of claim 1, further comprising:
receiving signal quality metrics from the mobile device indicating the quality of the pilot signal as measured at the mobile device, wherein the signal quality metrics from the mobile device are based on one or more of a Bit Error Ratio (BER), a Signal-to-Noise-Ratio (SNR), and a Received Signal Strength Indication (RSSI); and
adjusting the operational pilot signal power level of the access point based on the signal quality metrics.

10. The method of claim 4, wherein:
sending the relocation prompt to the mobile device instructing the mobile device to locate to the specified location comprises transmitting an audible voice message to the mobile device via a wireless telephony link instructing the mobile device to locate to the specified location; and wherein
receiving the relocation confirmation message from the mobile device indicating the mobile device is in the specified location as instructed by the relocation prompt comprises receiving the relocation confirmation message from the mobile device via the wireless telephony link, the relocation confirmation message in the form of audible tones transmitted via the wireless telephony link.

11. The method of claim 4, wherein:
sending the relocation prompt to the mobile device instructing the mobile device to locate to the specified location comprises transmitting a Short Message Service (SMS) text message to the mobile device instructing the mobile device to locate to the specified location; and wherein
receiving the relocation confirmation message from the mobile device indicating the mobile device is in the specified location as instructed by the relocation prompt comprises receiving the relocation confirmation message from the mobile device in the form of a responsive SMS text message.

12. The method of claim 1, further comprising:
distributing a mobile platform application to the mobile device via a wireless interface for use in calibration of the pilot signal; and wherein
the pilot signal acknowledgement received from the mobile device is received at a calibration application executing in the access point from the mobile platform application executing in the mobile device via an application message.

13. The method of claim 1, further comprising:
automatically configuring an electronically steerable antenna based on the power level at which the pilot signal was transmitted when the pilot signal acknowledgement was received.

14. The method of claim 14, wherein automatically configuring the electronically steerable antenna comprises:
prioritizing the directionality of signal patterns transmitted from the access point; and wherein
automatically configuring the electronically steerable antenna is based further on one or more quality signal metrics as measured at the mobile device and received from the mobile device with the pilot signal acknowledgement, the quality signal metrics comprising a Bit Error Ratio (BER), a Signal-to-Noise-Ratio (SNR), and a Received Signal Strength Indication (RSSI).

15. The method of claim 1, wherein the access point comprises a femto cell base station.

16. An access point comprising:
means for determining a pilot signal power level at which a mobile device operating in a specified location detects a pilot signal broadcast from the access point; and
means for automatically calibrating a pilot signal boundary established by the pilot signal based on the pilot signal power level at which the mobile device detects the pilot signal.

17. The access point of claim 16, further comprising:
means for deploying a mobile application to the mobile device; and
means for sending mobile application messages to the mobile application executing on the mobile device, the application messages instructing the mobile device to relocate to one or more specified locations and acknowledge when the pilot signal is detected at each of the one or more specified locations.

18. The access point of claim 17, wherein determining the pilot signal power level at which the mobile device operating in the specified location detects the pilot signal comprises:
means for receiving a pilot signal acknowledgement at a calibration application executing within the access point, the pilot signal acknowledgement received from the mobile application executing on the mobile device.

19. An access point comprising:
a relocation prompt transmitter to transmit a message to a mobile device, the message to instruct the mobile device to relocate to a specified location;
a power level setter to cause the access point to transmit a pilot signal until a pilot signal acknowledgement is received from the mobile device indicating the pilot signal was detected at the specified location; and
a pilot signal acknowledgement receiver to receive the pilot signal acknowledgement from the mobile device.

20. The access point of claim 19, wherein the power level setter to further automatically set an operational pilot signal pilot level for the access point, without human intervention, based on a power level in effect when the pilot signal acknowledgement was received.

21. The access point of claim 20, further comprising:
a mobile application deployment transmitter to deploy a mobile application to the mobile device for execution on the mobile device; and wherein
the pilot signal acknowledgement received from the mobile device is received from the mobile application.

22. A method of calibration using a mobile device, comprising:
prompting a service subscriber to locate to a specified location responsive to receiving a relocation prompt from an access point; and
sending a pilot signal acknowledgement to the access point via the mobile device indicating a pilot signal was detected at the specified location.

23. The method of claim 22, further comprising:
the service subscriber physically relocating the mobile device to the specified location responsive to the relocation prompt;
the mobile device sending a relocation confirmation to the access point responsive the to service subscriber physically relocating the mobile device to the specified location; and
the mobile device detecting the pilot signal at the specified location.

24. The method of claim 22, further comprising:
the mobile device sending signal quality metrics to the access point via a mobile application executing on the mobile device, the signal quality metrics describing measurable characteristics of the pilot signal as received at the specified location.
